(19) United States
(12) Patent Application Publication
(10) Pub. No.: US 2008/0162548 A1
(43) Pub. Date: Jul. 3, 2008

(54) Object oriented, semantically-rich universal item information model

(76) Inventors: Zahid Ahmed, San Jose, CA (US); Alan Bush, Mountain View, CA (US); Herb Stiel, San Francisco, CA (US); Shashi Suravarapu, San Ramon, CA (US); David Yee, Mountain View, CA (US)

Correspondence Address: DLA PIPER US LLP, 2000 UNIVERSITY AVENUE, E. PALO ALTO, CA, 94303-2248, US

(21) Appl. No.: 11/647,973

(22) Filed: Dec. 29, 2006

(51) Int. Cl. G06F 7/00

(52) U.S. Cl. 707/103 R; 707/E17.055

(57) ABSTRACT

An object-oriented, semantic information model and method are provided.

### APPENDIX

Appendix A (38 pages) is a listing of the base component and types of an exemplary embodiment of the information model (using a Universal Item Description Language described below) and forms part of the specification.

### FIELD OF THE INVENTION

An object oriented, semantic information model is provided which is the basis for a universal item schema framework,

### BACKGROUND

Schemas and model for representing information are well known. For example, the well known extended mark-up language (XML) schema is an example of a schema and model to represent certain types of information. Additionally, there are other well known information schemas and models. However, these schemas and models do not provide the ability to integrate any type of information consumed, published or shared over the web or the intranet. The integration of various types of information requires a unified model of describing the characteristics of the information which is not provided by existing information models and schemas. Thus, these existing information models and schemas do not provide a mechanism to handle information from disparate sources as is needed currently in the areas of social networking, consumer-oriented and business-oriented application integration platforms. Thus, there is a need for an item information model and system that overcomes the problems with existing information models and schemas.

The current approaches for finding and tagging information using free-form text is inefficient and a hit-and-miss affair. Many social networking and internet portal sites support tagging using the free-form text approach since it is simple to use and can be associated with a community of users who refer to items of interests using some label and meaning that is shared. However, there is a need to supplement existing free-form text based tagging with additional ways of classifying and labeling an information item in a personalized and efficient way.

Additionally, there are existing information and item models, but those models are specific to a transaction or a type of transaction and do not provide a universal item information model. For example, ebXML and UBL only cover B2B information while known commerce item models, such as those of eBay and Amazon, only cover ecommerce transactions.

### BRIEF DESCRIPTION OF THE DRAWINGS

FIG. 1 illustrates a storage device that holds a universal item information model;

FIG. 2 illustrates a universal information model;

FIG. 3 an exemplary implementation of a data structure for an AbstractItemKind;

FIG. 4 illustrates an example of a schema definition that defines an AbstractItemKind that has an <ItemDetails> element of type BasicItemDescriptorType;

FIGS. 5A and 5B illustrate an example of a ContactItem kind;

FIGS. 6A and 6B illustrate an example of a PhotoKind;

FIGS. 7A and 7B illustrate an example of a BookKind;

FIGS. 8A and 8B illustrate an example of an AutoKind;

FIGS. 9A and 9B illustrate an external content model;

FIG. 10 illustrates examples of the content kinds encapsulated using the universal item information model;

FIGS. 11A-11D illustrate further details of the system tag shown in FIG. 4;

FIG. 12 illustrates further details of the system defined connections shown in FIG. 4; and

FIGS. 13A and 13B illustrate further details of the user defined connections shown in FIG. 4.

### DETAILED DESCRIPTION OF AN EMBODIMENT

The invention is particularly applicable to a XML-based schema framework for item kinds and it is in this context that the universal information model and method will be described. It will be appreciated, however, that the object-oriented, semantic information model and method may be used to represent objects or components of data other than the exemplary items and that the object-oriented, semantic information model and method may be implemented using languages and schema other than XML or XML Schema Definition (XSD) language.

A universal item information model is presented that accomplishes several goals and overcomes certain problems that have existed. In particular, the universal item information model can be used to personalize and simplify the process of content consumption, sharing and publishing in a system in which various types of existing and new user-defined content needs to published, consumed and shared by and from various sources. The universal item information model addresses data integration from disparate sources as is needed currently in the areas of social networking, consumer-oriented and business-oriented application integration platforms. The universal information model also provides the ability to preserve and leverage existing and legacy content formats within the universal item information model such that interoperability with existing consumers and publishers and their applications is possible within a networked community environment where a system supports the handling of all kinds of new and existing content.

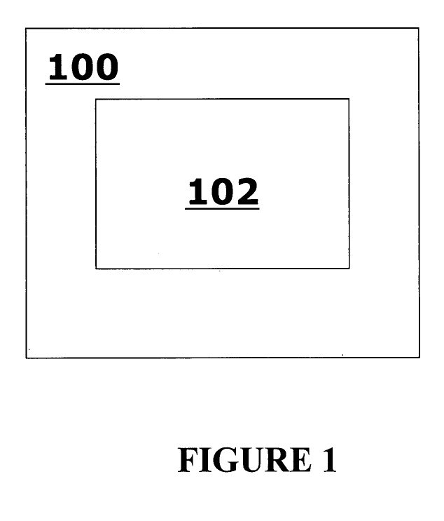

FIG. 1 illustrates a storage device 100 that holds a universal item information model 102 or a universal information model data structure. The storage device 100 may be a memory device, such as flash memory, static random access memory (SRAM), dynamic random access memory (DRAM), ROM, EPROM, EEPROM and the like that is part of a computing device and is resident in the memory device for at least some predetermined amount of time, a database record or table and/or a data structure that is part of one or more lines of computer code. The universal information model may be used, for example, as the basis for a data structure contained in a software module or program wherein the universal item information model is used to manage various different pieces of information in an information management system and it is this implementation of the universal item information model that is described wherein the universal item information model is a hierarchical and extensible semantic model for a class of items that may be used to model various different pieces of content within a system that can be used to publish, consume, share and take other actions on the content.

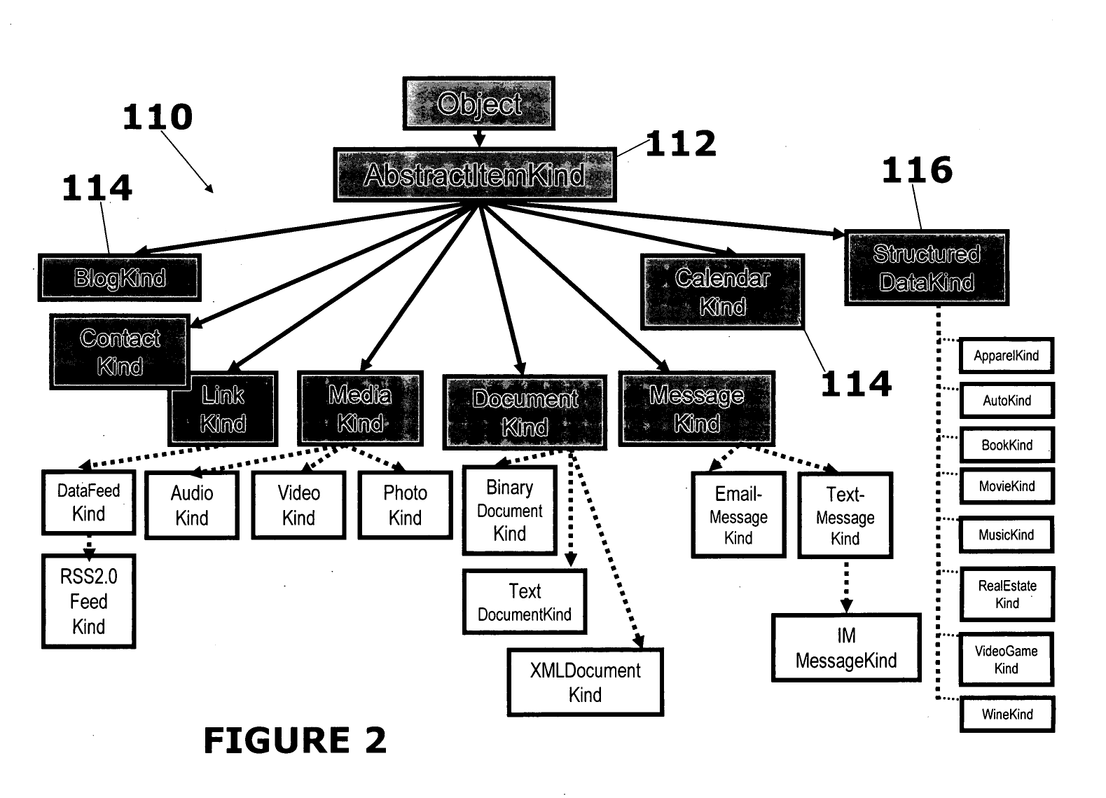

FIG. 2 illustrates a universal item information model 110 for an item that is an exemplary embodiment of the universal item information model. The universal item information model for an item may be used to support a pluggable content model such that the model can describe any item using a generic item description (an AbstractItemKind 112) that is applicable to any type of information item. The underlying item's format is preserved via encapsulating (or wrapping) the original item in a type-specific container item defined within the universal information model. The type-specific container item are created using specialized component types that employ the Universal Item Information Model that has an AbstractItem kind component which describes any item using a generic abstract definition. Extending the AbstractItem component via type-specific container item kinds allows the creation of a universal item information taxonomy that comprises various types of information, for example, BlogKind, CalendarKind, ContactKind, DocumentKind, LinkKind, MediaKind, etc. The direct extensions from the AbstractItemKind are referred to as the base component types (and their instances are referred to as base components) since they describe generally an item component within a general domain, for example, a MediaKind component refers to generally all kinds of media item. The base component types can be extended to additional specialized types to express specific characteristics, for example a PhotoKind extends the MediaKind. The universal item information taxonomy will also be referred as the universal item taxonomy. Hence, the type-specific container item kinds (representing specialized types of content and information) extend the AbstractItem component which is the base type of the model. The Universal Item Information Model allows a system to represent and manage the access, distribution, management and actionability of any type of item by describing its schema using the Universal Item Description Language (UIDL). The initial set of universal information item component types within the UIDL schema framework are expressed using the W3C XML Schema Definition (XSD) Language, but it is possible to describe the base and derived components of UIDL in various other object-oriented languages. New types of content created by a user or a user-defined application can be expressed by defining a new component type that extends from the AbstractItem base type and/or from one of the existing base component types already defined within the Universal Item Taxonomy, for example, the DocumentKind or MediaKind if it is a new type of document-oriented or media-oriented content. The new user-defined content (also referred as a new type of item) can be published or shared within a community of users as an instant of the newly defined component type. Hence, the Universal Information Model supports an extensibility mechanism that is needed to model, describe and instantiate new content generated or consumed by a user or a community or an application. This extensibility mechanism is within the framework of abstracting an information item as an AbstractItem from which any specific kind of information item can be derived as a specialized type.

Since the Universal Item Information Model (UIIM) and Universal Item Description Language (UIDL) can be employed to model and represent various types of information items, it should be noted that items expressed in UIDL can be stored in a database or in-memory cache, or transmitted on-the-wire over any communication channel (for example, HTTP, TLS, SMTP, SMS), or instantiated by an application service—all of these scenarios can employ the same description of the item based on UIDL.

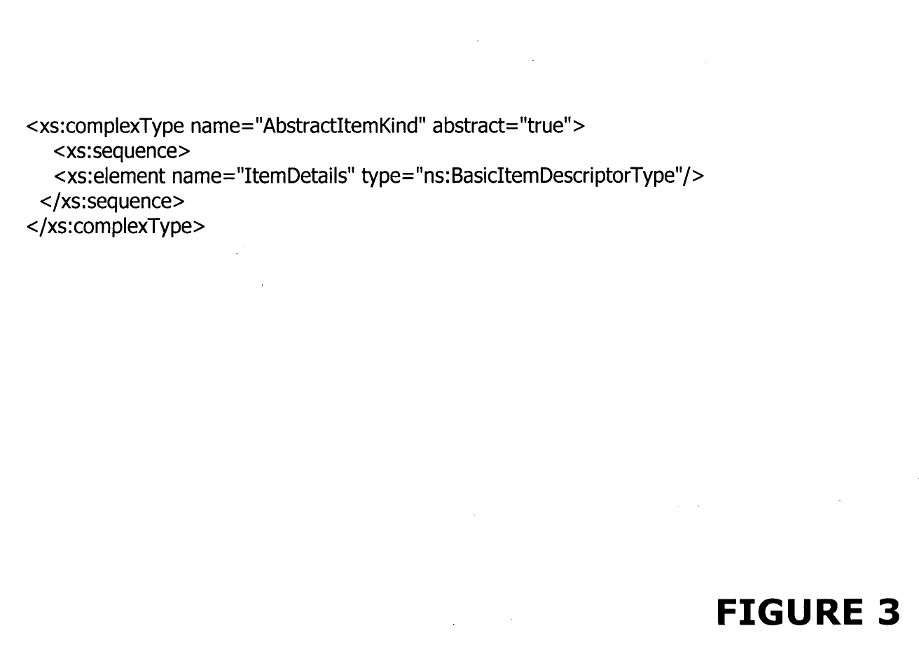

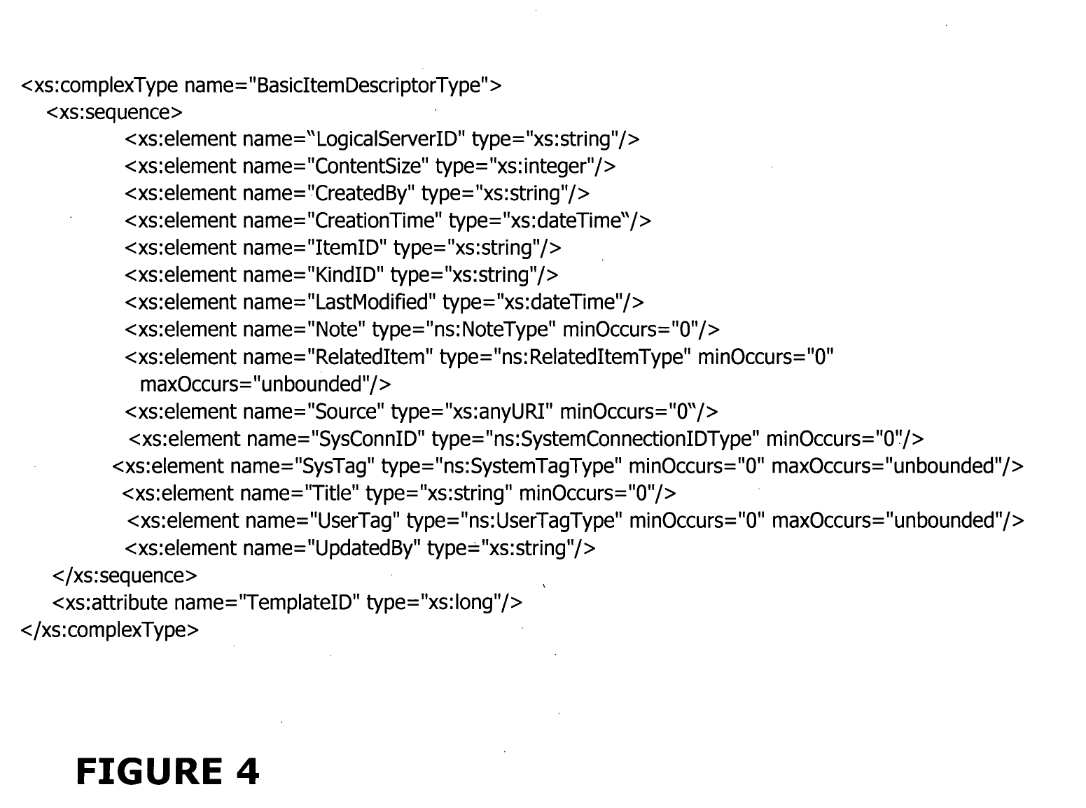

FIG. 3 illustrates an exemplary implementation of a data structure for an AbstractItem and FIG. 4 illustrates an example of a schema describing an AbstractItemKind. The AbstractItemKind is an abstract base type for all item content definitions (since all of the other item definitions are based on the AbstractItem and inherit the characteristics of the AbstractItem due to the inheritance of the object model) and is therefore reusable. Hence, the AbstractItem provides the base characteristics of each item in a system.

The AbstractItemKind includes sub-components that describe the general characteristics of any item in one or more general characteristics elements, such as the data structure fields shown in FIG. 4. These general characteristics are independent of the type of item and are included as part of the <ItemDetails> sub-element that Item instances inherit from the base type AbstractItemKind. A set of examples of the general characteristics of an item are:
LogicalServerID—this refers to some logical application and content server where the item is located and managed;
ContentSize—the size of the underlying content in bytes;
CreatedBy—the user who published (or inserted) an item; this user may or may not be the original publisher of the content rather the user who actually inserted (or copied) the content to a particular application and content server;
CreationTime—the date and time when the item was published (or inserted) via an application; this time may or may not be original publication date or time of the content rather the user who actually inserted the content in a particular application and content server;
ItemID—specifies the unique item identifier of the information item;
KindID—specifies the unique identifier to identify the type of content that the item instance is of;
LastModified—specified the date and time when the item was last modified;
Title—specifies a title of the item, e.g., this may be the Subject of the email or title of a book instance;
UpdatedBy—specifies the user who last modified the item;

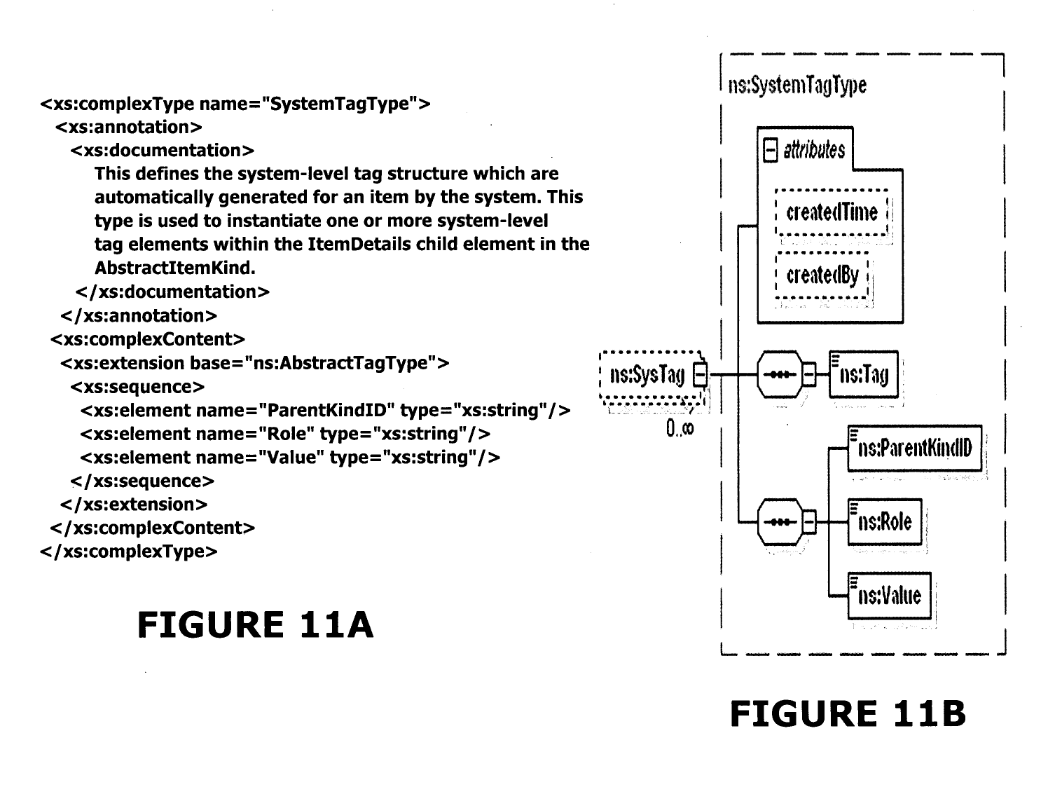

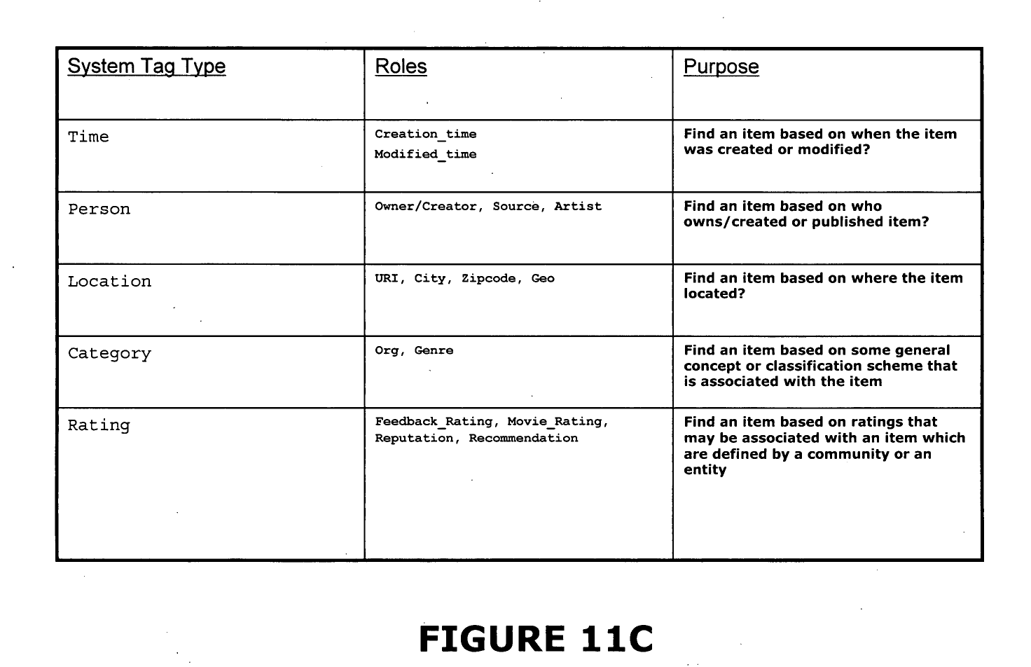

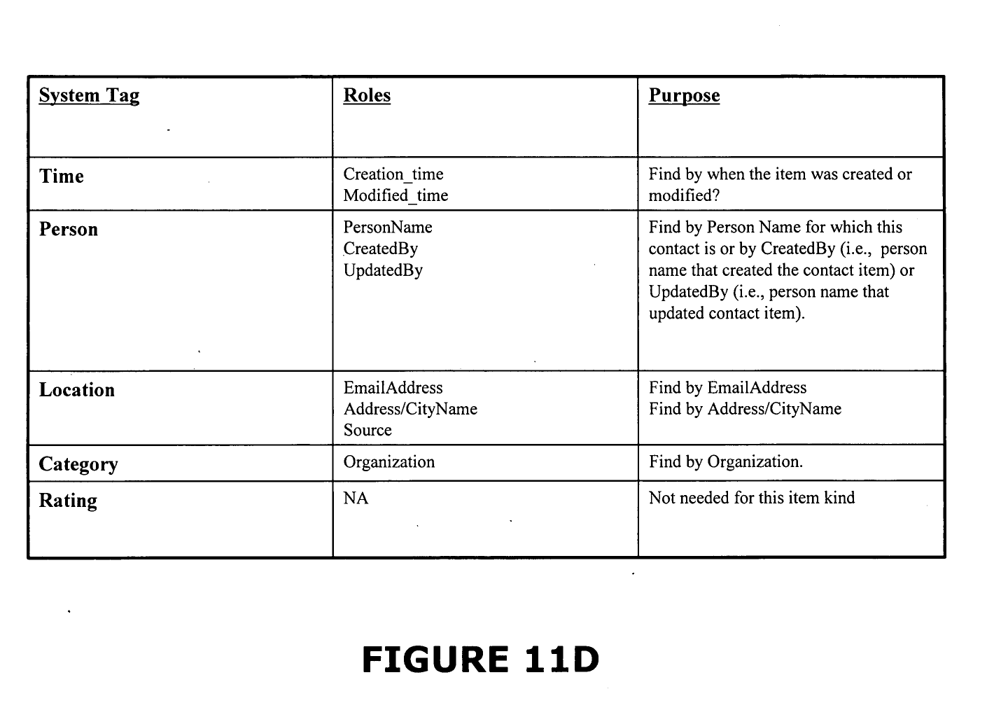

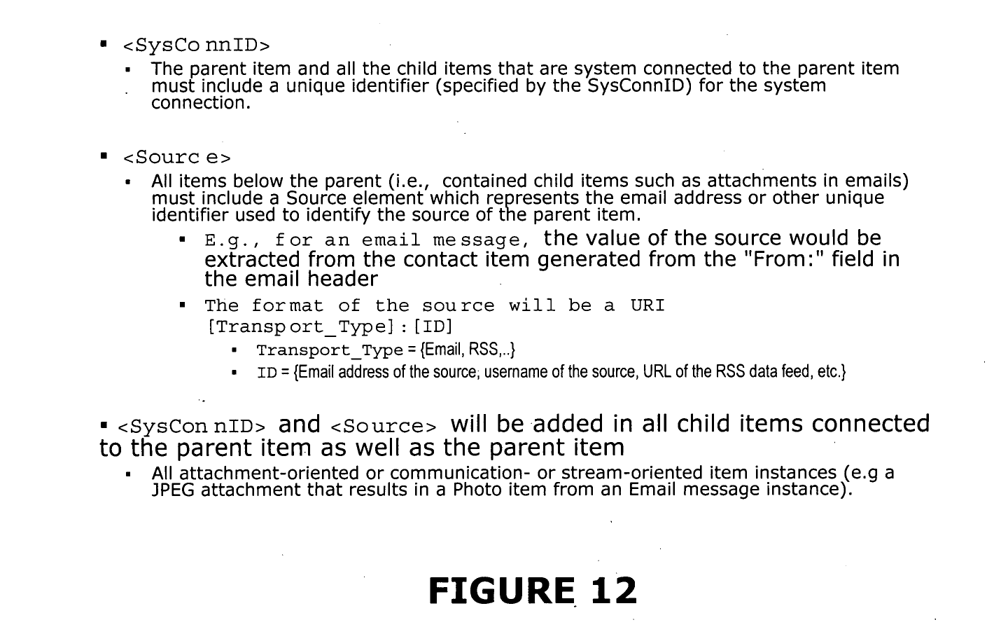

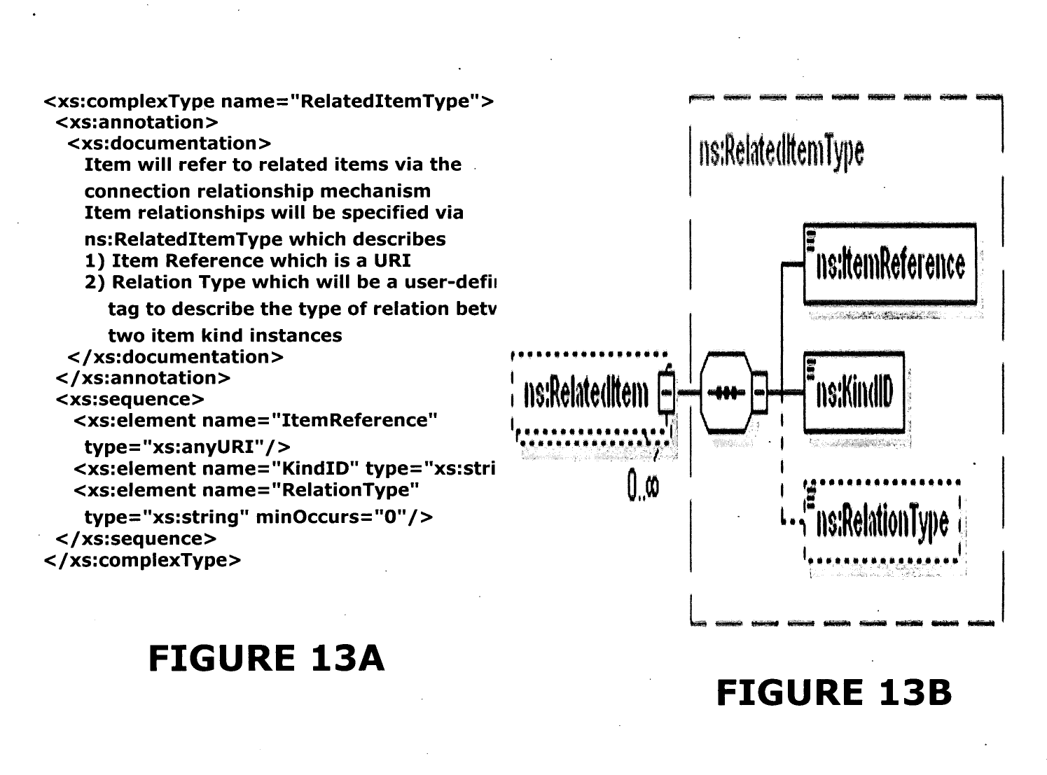

The AbstractItem kind also includes sub-components that describe various semantic characteristics of any item (using one or more semantic property elements) as part of the <ItemDetails> child element that Item instances inherit from the AbstractItem component. These semantic characteristics provide capabilities to describe additional information about a specific content, i.e., item instance, in a personalized and context specific way such that it can be used for various search, information navigation and filtering and other actions applicable to a content of a certain type. The semantic properties can be expressed uniformly for all kinds of information items by defining various semantic components within the AbstractItem component. This approach implies that derived types of content (e.g., a item instances of the types PhotoKind or a BlogKind or an AutoKind) that are extensions of the AbstractItemKind component would inherit identical sets of semantic properties which are therefore applicable to all instances of those derived item types. Following is a set of semantic elements defined as part of the <ItemDetails> child element of the AbstractItem component:
Zero or more user-defined tags (represented by the <UserTags> child element) which are free-form text entered by the user to add additional meaning or context to a specific information item;
Multiple system-managed tags (represented by the <SysTag> child element) which are generated automatically by a system along some standardized set of attributes, for example, Time, Person, Location, Category, and Rating. It is expected that an application and content server, i.e., the system that processes the publishing or creation of an item would have capabilities to process the generic, semantic and type-specific descriptions of an item to generate the derived system-managed tags. The details of the system-managed tag model and structure is described in more detail below with reference to FIGS. 11A-11D;
Zero or more Notes (represented by the <Note> child element) which can be created by different users to describe an item in additional detail depending on the user's context and situation;
Zero or more user-defined connections which are used to connect related items to other item instances. The user-defined connections are described in more detail below with reference to FIGS. 13A and 13B;
Zero or more system-defined connections (described in terms of Source and SysConnID) which are generated automatically. For example, certain types of content that are received via a communication channel such as email instances (via SMTP protocol) or RSS data feed (via HTTP protocol) and there is a need to connect the received content (e.g., the email) with additional content that is referenced and/or is part of it. E.g., a Photo attachment or a URL link included in an email would result in system-defined connections between the email message instance and the Photo item and Link item instances. The system-defined connections are described in more detail below with reference to FIG. 12.

Thus, the AbstractItem specifies one or more general characteristic elements (that can contain general characteristics) and one or more semantic property elements (that can contain the semantic properties of a particular instance of an item) of each item in the model. Since the above generic characteristics and semantic characteristics are described in a generic way for any type of item (that may be content), the universal item information model can be used by various types of applications wherein the applications can uniformly process the generic and semantic components of any type of item. In one example of the use of the universal item information model, the flexibility of the universal information model can be used by a scalable and extensible media operating system which can host media-rich applications that will be shared and customized by a consumer-oriented user community or a business-oriented user community.

Returning to FIG. 2, the model may have one or more core component types that are use case independent and are primitive data types. The core component types may include an amount type, a binary content type, an identifier type, a measure type, a numeric type, a quantity type and a text type. The listing of the core component types for the exemplary embodiment of the information model is attached as Appendix A that forms part of the specification and in incorporated herein by reference. The model may also include one or more base components 114 (children of the AbstractItem) that are reusable item kinds that permit, in this example, a particular type of item/content to be stored using each particular type of item kind. The base components may include a BlogKind, a ContactKind, a LinkKind, a MediaKind, a DocumentKind, a MessageKind, a CalendarKind, an EventKind, a To-DoKind, a TaskKind, a PhotoKind, etc wherein each of these base components inherit characteristics from the AbstractItemKind and then further define the characteristics associated with the particular type of item, such as a photo piece of content defined by the PhotoKind. Some of the base components may have one or more extensions to additional of specialized kinds of sub-items, such as the MediaKind having an AudioKind, a VideoKind and a PhotoKind or the MessageKind having Email-MessageKind and a Text-MessageKind (that has a IM MessageKind) wherein the sub-items inherit the characteristics of the ItemKind from which the sub-item is based and then contain further characteristics of the particular type of sub-item/content. For example, the BinaryDocument Kind inherits the characteristics of the DocumentKind and then has further characteristics that are associated with the binary document kind. The schema may also include one or more aggregated components 116 that consist of combining and encapsulating multiple types of item kinds to create new complex item kinds focused on a particular industry or area. For example, we could combine as child elements a photo item of type PhotoKind with a note item for new aggregate and complex content type which also extendss directly from the AsFor example, the Structured DataKind may include an ApparelKind, an AutoKind, a BookKind, a MovieKind, a MusicKind, a Real EstateKind (for real estate related content/items), a VideoGameKind and a WineKind. The schema may further include vertical application domain extensions that are specialized extensions of the ItemKind. These items can be used for a particular vertical and/or community application domains.

For each base component (a kind of item in the example shown in FIG. 2), the universal information model also may include elements (for example data structure fields) that allow zero or more views, zero or more actions or zero or more constraints. The views, actions and constraints can be described separately from the schema definition of the item kind such that they are referenced back to the item kind identifier. This way we can ensure that views, actions, and constraints can be associated with the type of the item. Furthermore, views, actions, constraints can be defined at the AbstractItemKind component level such that they are inherited by the base components and other derived types of the base components.

Views

The zero or more views describe ways of displaying instances of the particular base component type (such as an ContactItem kind in the example above). Examples of some views that could be supported for a specific kind of item may include 1) display the item in a list view. E.g., for a contact item display the first_name and last_name elements such that each contact item appears in a single line; or 2) display an expanded view that displays all base component meta-data that is applicable to that kind of base component. In both cases the applicable elements are specified as part of the view specification for the particular base component type.

Actions

The zero or more actions may be applicable to processing an item of a given type. Examples of generic actions that can be supported for all kinds of items are: AddItem, UpdateItem, and DeleteItem. Examples of some of the actions that could be supported for an item that is of particular type, for example, a Contact kind (shown in FIG. 2) may include: addMember or importVCard. Each type of action for a specific base component (kind of an item in the item model shown in FIG. 2) can be expressed in terms of the name of the action, parameters that will be passed to the method that will process the action, and the type of return value. For example, the action specification for the importVCard action for the Contact item kind may be:

<action name=“importVCard” componentAction=“contact.ImportVCard”
uiLabel=“ImportVCard”>
<parameter dataType=“stream” name=“vcard” uiLabel=“VCard file”/>
<returnType>items</returnType>
</action>

A second example of an action that can be associated with an item kind are ones which refer to a one or more service providers that can process an item. For example, a photo item may have PrintAction that is processed by a web-based photo printing service provided by a third-party. Here is an example specification to reference a service provider that can process an action associated with a specific item kind:

```
<xs:complexType name=“ItemActionLinkKind”>
  <xs:complexContent>
  <xs:extension base=“ns:AbstractItemKind”>
    <xs:annotation>
    <xs:documentation>
      This specifies the invocation of a third-party web application
      or resource over HTTP Protocol. The invocation mechanism
      and parameters are included in the specification such that
      the consuming application can compose and invoke the
      URL at run-time.
</xs:documentation>
    </xs:annotation>
    <xs:sequence>
    <xs:element name=“Name” type=“xs:string”/>
    <xs:element name=“Description” type=“xs:string” minOccurs=“0”/>
    <xs:element name=“ItemKindID” type=“xs:string”/>
    <xs:element name=“BaseURL” type=“xs:anyURI” minOccurs=“0”/>
    <xs:element name=“InvocationType”
    type=“ns:HttpInvocationType”/>
    <xs:element name=“Parameter” type=“ns:ItemActionParameter”
minOccurs=“0” maxOccurs=“unbounded”/>
    </xs:sequence>
    <xs:attribute name=“category” type=“xs:string” use=“optional”/>
  </xs:extension>
  </xs:complexContent>
</xs:complexType>
```

A third example is of an action (associated with an item kind) that is processed by a business process which is invoked by an API.

Constraints

The zero or more constraints may be applicable to items of a given type (i.e., an instance of an item kind in the exemplary universal item information model). The constraints may include type constraints and/or semantic constraints. The type constraints for each child element of an item are part of the XML schema definition. The semantic constraints may be applicable to any or all elements within the item. Furthermore, the semantic constraints express which combinations of item element values are acceptable as possible values within the information system. For example, for an element representing a <PostalCode>, the constraint can limit the data entered by the end user to be numeric even if the type definition of this element is xsd:string type within the XML schema namespace. For an element representing <Phone>, the constraint can limit the data entered to be of a specific format and length. Another example is that of a contact item can not have a child element <Gender> have value equal to “Male” and an another child element <Relationship> equal to “Mother”.

The views, actions and constraints may be expressed in data structure specifications outside the item kind definition such that they are referenced (and inherited) via an identifier to the AbstractItemKind component which is the base type of all items, or referenced via an ItemKindID identifier to another base component that is derived from the AbstractItem kind, or referenced via an ItemKindID identifier directly to a particular item kind definition. This way these views, actions and constraints can be applied to an item kind included in the universal information model.

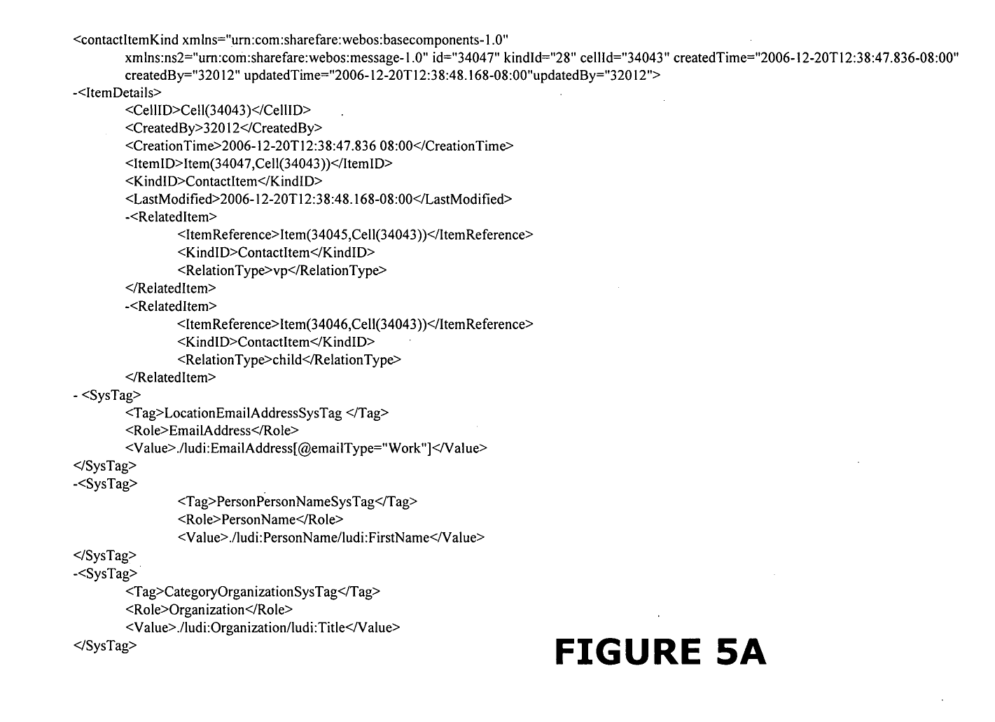

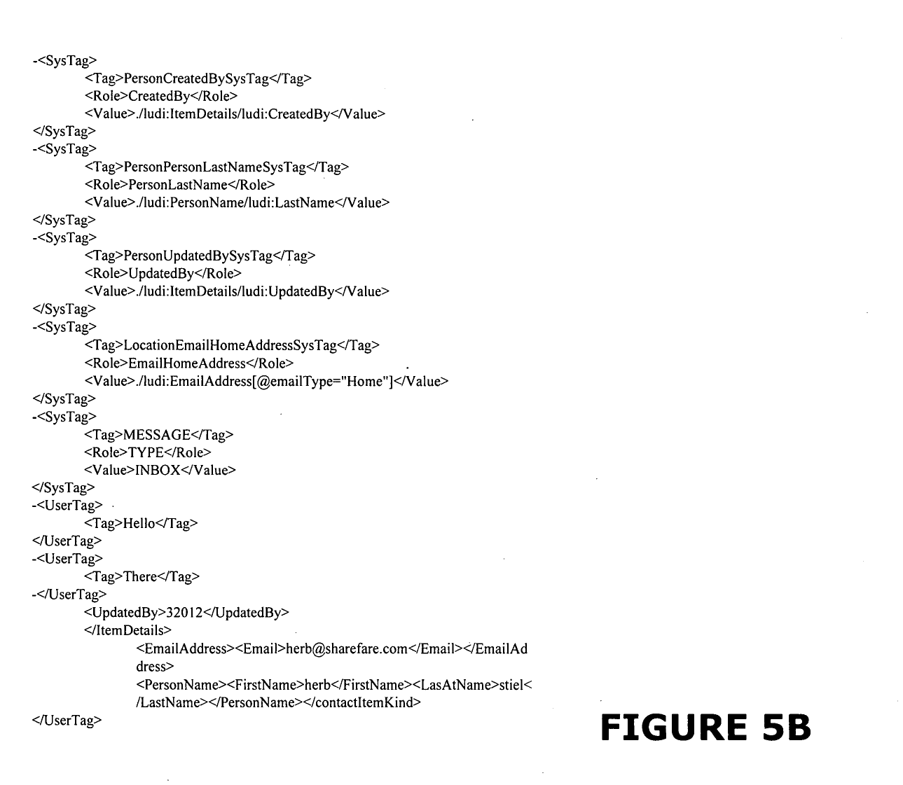

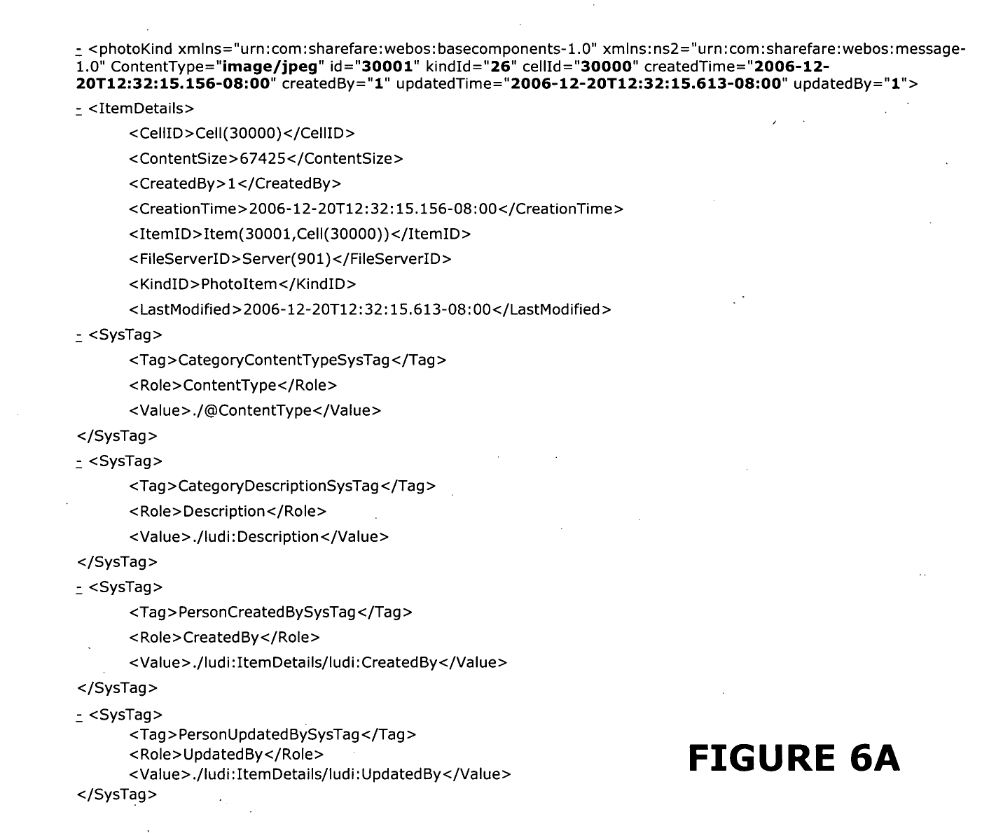

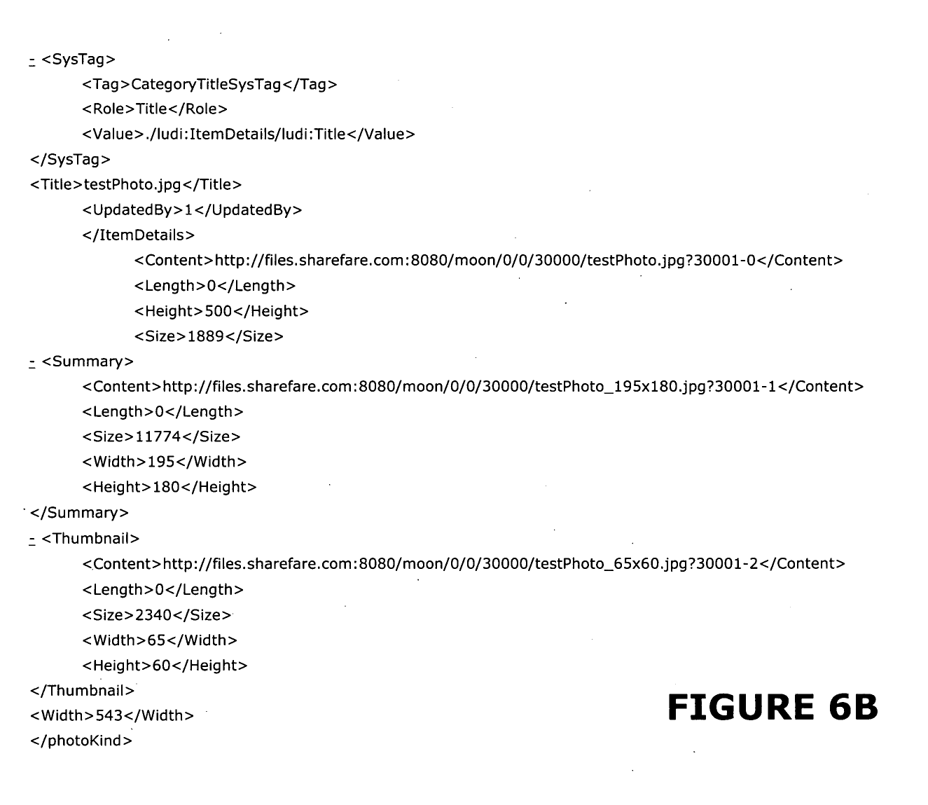

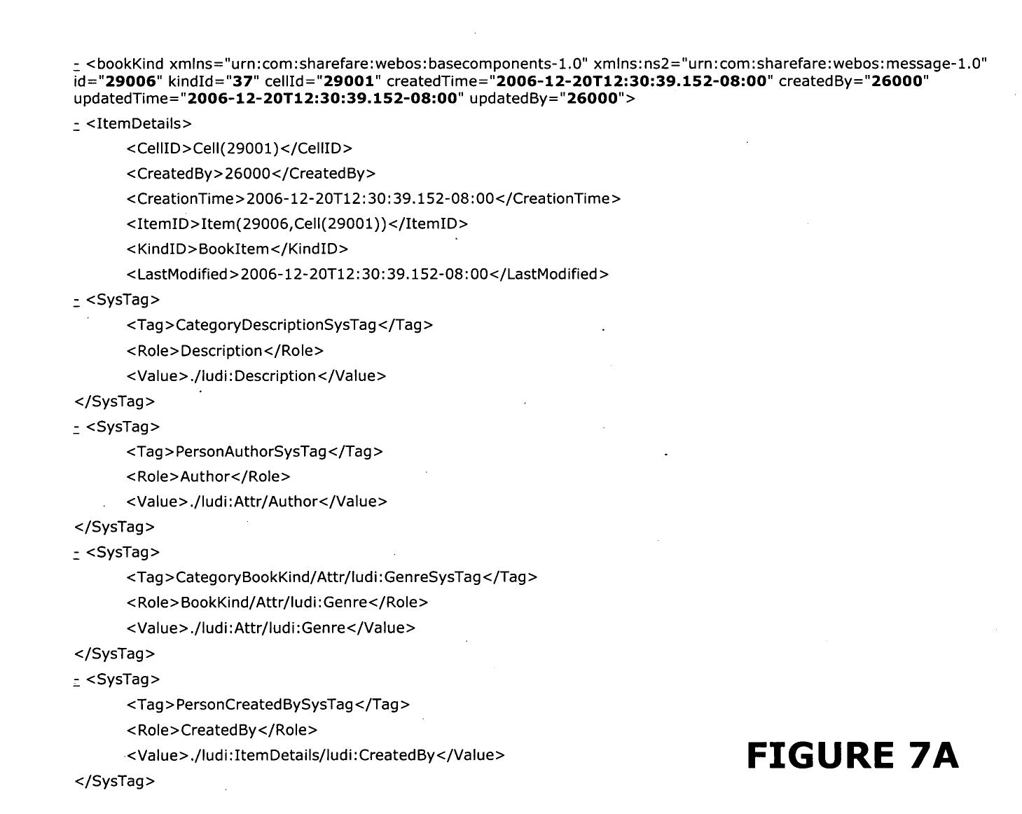

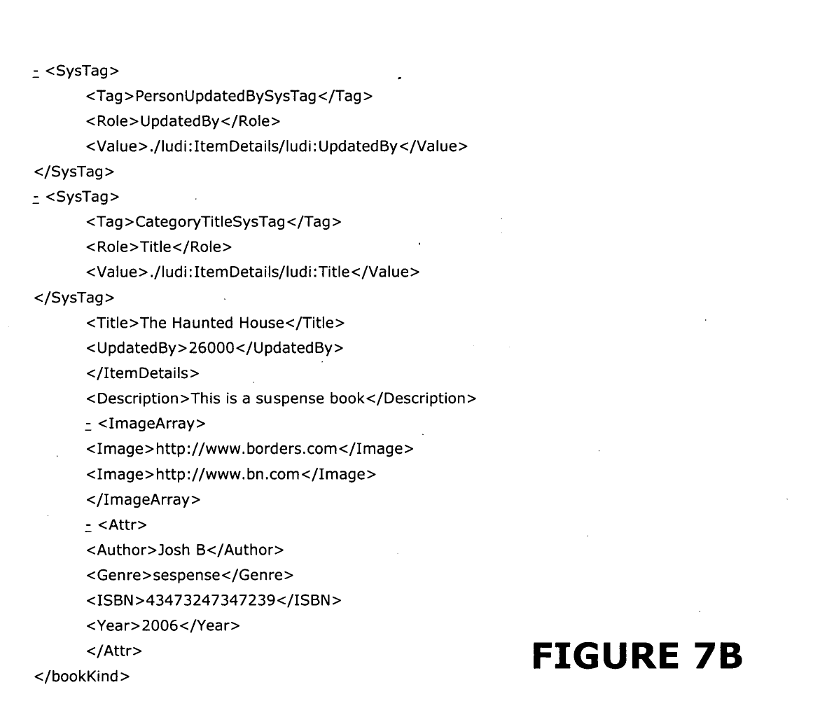

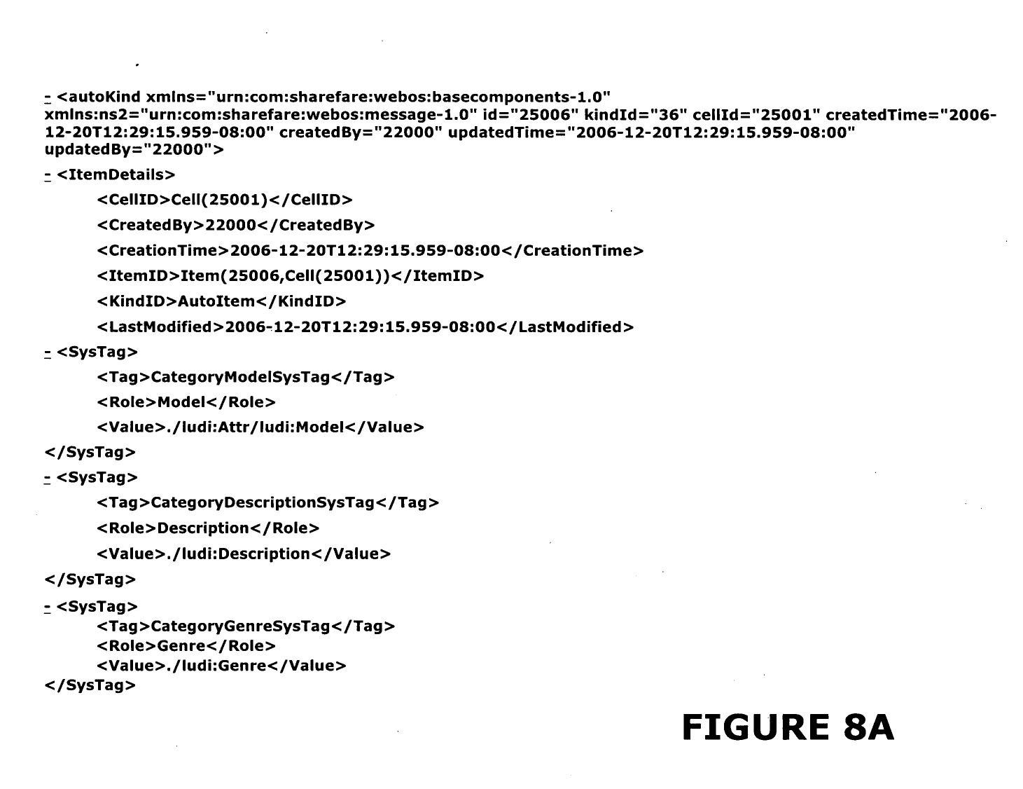

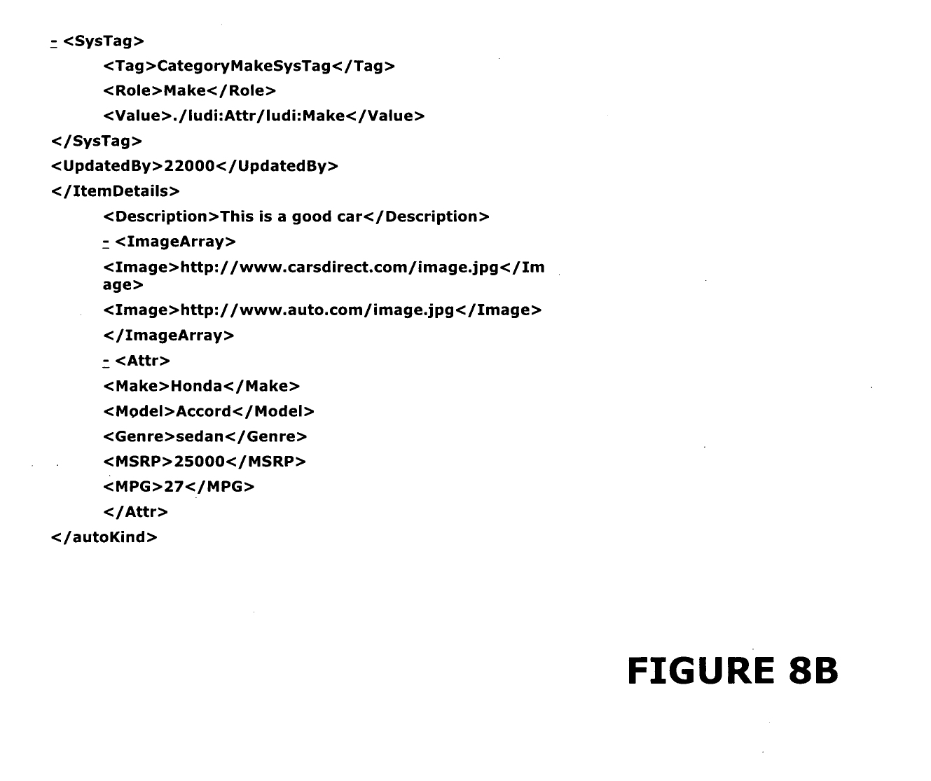

FIGS. 5A and 5B illustrate an example of a ContactItem kind. The ContactItem kind has the item details and also has examples of the system and user defined tags wherein the system tags are generated by a system that utilizes the universal item information model while the user tags may be generated by the user of the system that uses the universal item information model. Similarly, FIGS. 6A and 6B show a PhotoKind that has the item details (the generic characteristics of the PhotoItem) and both system and user tags. The PhotoKind example also includes a photo and thumbnail that are incorporated into the PhotoKind. Similarly, the BookKind (shown in FIGS. 7A and 7B) includes the item details, the system and user tags and also encapsulates a particular book (“The Haunted House”) along with information about the particular book and the AutoKind (shown in FIGS. 8A and 8B) includes the item details, the system and user tags and also encapsulates a particular car (a “Honda Accord”) along with information about the particular car.

As set forth above, the universal item information model may have vertical application domain extensions that are specialized extensions of the ItemKind. There are multiples ways to extend the Universal Item Information Model to support domain specific needs of a particular class of applications. For example, three techniques can be used to support extensions for vertical application domains and those techniques are:

1) To support specialized extensions needed by a particular domain or use case, for example, a real-estate application, it is possible to extend the existing types of item kinds. As an example, it is possible that the <Note> component (shown in FIG. 4) needs to have additional properties such as a special identifier of the EmployeeID of the real-estate broker as part of the extended <Note> component. Such additional properties can be added for a vertical application domain by extending existing NoteKind XML complex type as follows:

```
<xs:complexType name=“RealEstateNoteKind”>
  <xs:complexContent>
  <xs:extension base=“ns:NoteKind”>
      <xs:sequence>
        <xs:element name=“EmployeeID” type=“xs:string”/>
      </xs:sequence>
  </xs:extension>
  </xs:complexContent>
</xs:complexType>
```

2) Certain application domains may also need to combine existing kinds of content together for specialized complex types, for example, <Note> and <Photo> component may need to be combined for a particular type of aggregated component needed for the real-estate domain.

3) If the above two methods of extensions do not address the needs of a specific domain, it is possible to extend the AbstractItem component to a specialized base type.

The new types of schema components could also be defined in its own XML schema namespace that is dedicated to a particular vertical application domain such that all the general and semantic character tics and other applicable base component characteristics (if extension carried out from an existing base component type) are inherited by the extension defined within the namespace of the vertical application domain.

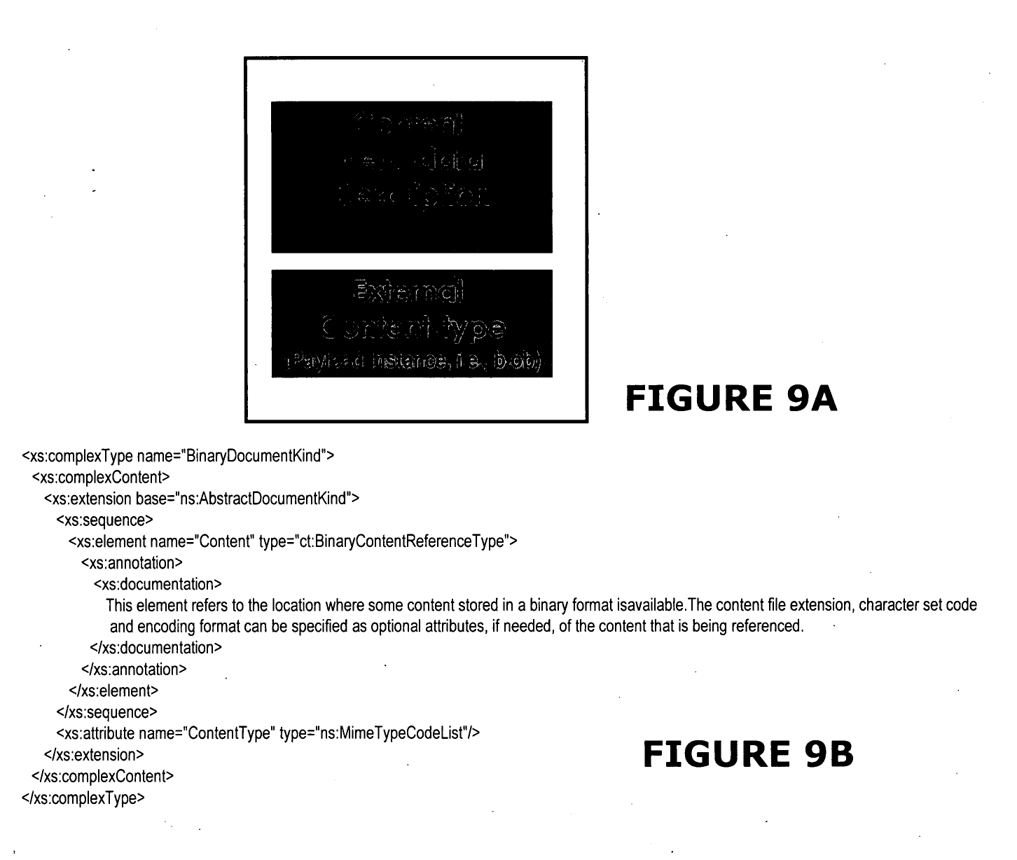

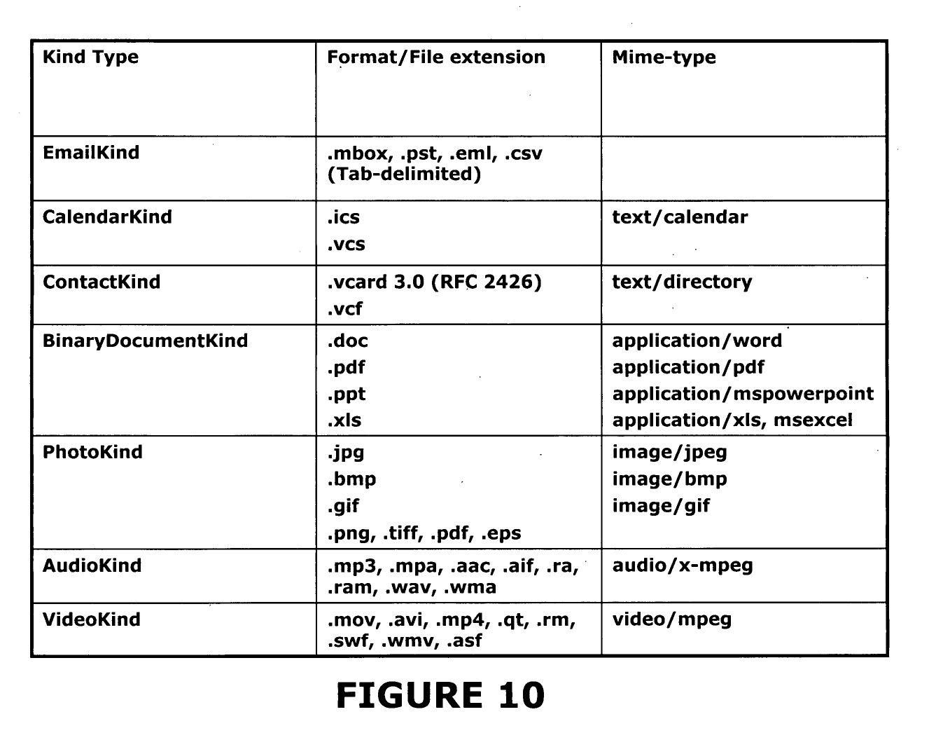

FIGS. 9A and 9B illustrate an external content model and FIG. 10 illustrates examples of the content kinds generated using the universal information model. The universal information model provides a model for handling external content. External content typically will be in existing formats that are standardized for media files (for example, .jpeg photo file or .mpeg video file formats), documents produced by various authoring tools (for example, .doc, or .txt or .pdf file formats), or other business documents that are formally defined and used by a community of users via XML-based Web Services (for example using an Item schema component representing an item for sale at Amazon.com or an item that is being auctioned by a seller at eBay.com; or, a Rental item described at some realtor site). The mechanism employed to handle (i.e., allow storage, access and processing of) externally defined content (as shown in FIG. 9A) will be by:

1) Describing the underlying externally defined content using generic meta data description included in the AbstractItemKind component which is applicable to any information item (or content), i.e., both user-defined content and other externally-defined content Such generic meta-data description for any information item (whether defined externally by a 3^{rd} party or directly and locally as user-defined content) is expressed within the <ItemDetail> element of the AbstractItem component; and

2) Wrapping the externally-defined content into an external content element that can carry any kind of content, i.e., including binary content or other specially formatted content as well as content that has a formalized XML schema definition within a namespace owned or managed by a particular business service entity.

Since external content would be processed as a derived type of AbstractItem kind, any kind of content will have fundamentally identical base type definitions that allows external content created by third parties to be generally processed by a system that uses the information model via a combination of generic AbstractItem handler for common information item processing functions and content-type specific handler to process the underlying format-specific content using a 3^{rd} party specific application library. This approach allows seamless integration of external content which can be “plugged-in” to any system which uses the Universal Item Taxonomy since there is no need to transform the format of the external content. FIG. 9B illustrates an example of the data structure for the Kind that handles the external binary content. The approach of representing an external content kind permits re-use of externally defined content from various sources via a generic meta data expression and processing mechanism (for any kind of external content) which will allow interoperability with existing content service providers and applications that use or generate content in various existing content formats and also make the content into derived type within Universal Item Taxonomy.

FIGS. 11A-11D illustrate further details of the system tag shown in FIG. 4. In particular, an example of the data structure for a system-managed tag is shown in FIG. 11A and an example of a model for the system-managed tag is shown in FIG. 11B. Each system-level tag may include one or more roles. The roles refer to specific elements within the <ItemDetails> child element within the AbstractItemKind and/or elements within specific base component type that the item is an instance of. Hence, the roles are used at run-time by the system to extract particular characteristics of an item that can be normalized (or mapped) to specific dimensions (i.e., types of system-level tags) of the system-level tags. Furthermore, the values of these roles can either be determined on-the-fly by, for example, the XPath references to the actual values within the specific elements that are referenced for the roles or stored explicitly with item instances when they are inserted or published into the information system. Lastly, the system level tag model implies that multiple roles can be specified for a particular type of system-level tag. Also, System-level tag structure is applicable in a type-independent way to semantically extract relevant characteristics of all items according to well-known system level tag types.

FIG. 11C illustrates the system-level tag types along with the one or more roles and purpose for each different type of tag. In particular, the system-level tags may include a Time (with roles of Creation_time and Modified_time and the purpose of finding an item based on when the item was created or modified), Person (with roles of Owner/Creator, Source and Artist and the purpose of finding an item based on who owns/created or published an item), Location (with roles of URI, City, Zipcode and Geo and the purpose of finding an item based on where the item is located), Category (with roles of Org and Genre with the purpose of finding an item based on some general concept or classification scheme that is associated with the item) and Rating (with roles of Feedback_Rating, Movie_Rating, Reputation and Recommendation with the purpose of finding an item based on ratings that may be associated with an item that are defined by a community or an entity) types of system-level tags. FIG. 11D illustrates an example of the system-level tags for the ContactItem kind shown in FIGS. 5A and 5B with the one or more roles and the purpose of each type of system-level tag for the ContactItem Kind shown in FIG. 11D.

FIG. 12 illustrates further details of the system defined connections shown in FIG. 4. As shown in FIG. 4, each system defined connection may include a <SysConnID> element and a <Source> element. The <SysConnID> element contains a unique identifier for each system defined connection that the parent item and all the child items that are system connected to the parent item include the unique identifier (specified by the SysConnID element.) The <Source> element represents an email address or other unique identifier used to identify the source of the parent item wherein all items below the parent (i.e., contained child items such as attachments in emails) include the <Source> element. For example, for an email message, the value of the source would be extracted from the contact item generated from the “From:” field in the email header. The format of the source will be a URI [Transport_Type]: [ID], such as Transport_Type={Email, RSS, . . . } and ID={Email address of the source, username of the source, URL of the RSS data feed, etc.}.

The <SysConnID> and <Source> elements will be added in all child items connected to the parent item as well as the parent item. All attachment-oriented or communication- or stream-oriented item instances (e.g a JPEG attachment that results in a Photo item from an Email message instance).

FIGS. 13A and 13B illustrate further details of the user defined connections shown in FIG. 4. The user defined connections permit a user to relate a given item with one or more related items in an information management system such that the connections between the items are implemented as two-way links specified in the item instance. FIG. 13A illustrates an example of the data structure for the related item type (the user defined connection). As shown in FIG. 13A (and in the example shown in FIG. 5A), each related item type has a URI that identifies the connection, a KindID that identifies that kind type and a relation type element that defines the type of relationship defined by the particular related item type.

While the foregoing has been with reference to a particular embodiment of the invention, it will be appreciated by those skilled in the art that changes in this embodiment may be made without departing from the principles and spirit of the invention, the scope of which is defined by the appended claims.

1. A method for representing content in a system with a universal item taxonomy, the method comprising:
providing an abstract base type object for each content definition, the abstract base type object having one or more general characteristic elements of an object and one or more semantic property elements; and
providing a plurality of base components, each base component being a child of the abstract base type object and inheriting the one or more general characteristics, each base component being a container item kind that describes a type of object and encapsulates the particular type of object wherein each type of object associated with a system is represented by the abstract base type object and one of the base components.

2. The method of claim 1, wherein each base component has one or more semantic properties that are defined in the one or more semantic property elements.

3. The method of claim 2, wherein the one or more semantic property elements further comprise a tag associated with an object.

4. The method of claim 3, wherein a tag further comprises a tag generated by a user or an automatically generated tag.

5. The method of claim 4, wherein each automatically generated tag further comprises a tag type name, a role and a value of the role wherein the role is an element within the base component to which the tag is associated.

6. The method of claim 5, wherein the tag type name further comprises a time tag type, a person tag type, a location tag type, a category tag type or a rating tag type.

7. The method of claim 2, wherein the one or more semantic property elements further comprise a note associated with an object.

8. The method of claim 2, wherein the one or more semantic property elements further comprise a connection that connects a particular object with another object.

9. The method of claim 8, wherein the connection further comprises a connection generated by a user or an automatically generated connection.

10. The method of claim 9, wherein each automatically generated connection further comprises a unique connection identifier and an identifier of a source of the automatically generated connection.

11. The method of claim 1, wherein the one or more general characteristic elements of an object further comprises a LogicalServerID element, a ContentSize element, a CreatedBy element, a CreationTime element, an ItemID element, a KindID element, a LastModified element, a Title element, or an UpdatedBy element.

12. The method of claim 1 further comprising providing a plurality of aggregated components wherein each aggregated component further comprises one or more base components so that the aggregated component stores information about a content having one or more types of objects.

13. The method of claim 1, wherein the providing the abstract base type object further comprises providing an ItemKind data structure.

14. The method of claim 3, wherein providing the plurality of base components further comprises providing one or more of a BlogKind, a ContactKind, a LinkKind, a MediaKind, a DocumentKind, a MessageKind, a CalendarKind, an EventKind, a To-DoKind, a TaskKind, and a PhotoKind.

15. The method of claim 2, wherein the abstract base type object, the plurality of base components and the plurality of aggregated components each further comprise XML data.

16. The method of claim 5, wherein providing the MediaKind further comprises providing an AudioKind, a VideoKind and a PhotoKind, providing the MessageKind further comprises providing an Email-MessageKind and a Text-MessageKind and wherein providing the Text-MessageKind further comprises providing an IM MessageKind.

17. The method of claim 2, wherein providing the plurality of aggregated components further comprises providing one or more of an ApparelKind, an AutoKind, a BookKind, a MovieKind, a MusicKind, a Real EstateKind, a VideoGameKind and a WineKind.

18. The method of claim 1 further comprising creating a new base component for a new type of object, the new base component describing the new type of object and encapsulating the underlying content of the new type of object within a generic content element wherein the new type of object is represented by the new base component.

19. The method of claim 1, wherein the plurality of base components further comprises a vertical application domain item based on a base component that has a vertical application domain semantic property element.

20. The method of claim 1, wherein the abstract base type object further comprises a views element, an actions element and a constraints element wherein the views element describes zero or more display types associated with the abstract base type object, the actions element describes zero or more actions associated with the abstract base type object and the constraints element describes zero or more constraints associated with the abstract base type object.

21. The method of claim 20, wherein the views element, actions element and constraints element associated with the abstract base type object are inherited by the base component types that extend the abstract base type object.

22. The method of claim 1, wherein each base component further comprises a views element, an actions element and a constraints element wherein the views element describes zero or more display types associated with the base component, the actions element describes zero or more actions associated with the base component and the constraints element describes zero or more constraints associated with the base component.

23. The method of claim 22, wherein the views element, actions element and constraints element associated with a particular base component type are inherited by the objects that are derived from that particular base component type.

24. A computer-implemented universal item taxonomy, comprising:
an abstract base type object for each object definition, the abstract base type object having one or more general characteristics containers of an object and one or more semantic property containers; and
a plurality of base components, each base component being a child of the abstract base type object and inheriting the general characteristics, each base component describes a type of object and encapsulates the particular type of object wherein each type of object associated with the system is represented by the abstract base type object and one of the base components.

25. The taxonomy of claim 24, wherein each base component has one or more semantic properties that are defined in the one or more semantic property elements.

26. The taxonomy of claim 2, wherein the one or more semantic property elements further comprise tags associated with an object.

27. The taxonomy of claim 3, wherein the tag further comprises a tag generated by a user or an automatically generated tag.

28. The taxonomy of claim 27, wherein each automatically generated tag further comprises a tag name, a role and a value of the role wherein the role is an element within the base component to which the tag is associated.

29. The taxonomy of claim 28, wherein the tag type name further comprises a time tag type, a person tag type, a location tag type, a category tag type or a rating tag type.

30. The taxonomy of claim 2, wherein the one or more semantic property elements further comprise a note associated with an object.

31. The taxonomy of claim 2, wherein the one or more semantic property elements further comprise a connection that connects a particular object with another object.

32. The taxonomy of claim 8, wherein the connection further comprises a connection generated by a user or an automatically generated connection.

33. The taxonomy of claim 32, wherein each automatically generated connection further comprises a unique connection identifier and an identifier of a source of the automatically generated connection.

34. The taxonomy of claim 24, wherein the one or more general characteristic elements of an object further comprises a LogicalServerID element, a ContentSize element, a CreatedBy element, a CreationTime element, an ItemID element, a KindID element, a LastModified element, a Title element, or an UpdatedBy element.

35. The taxonomy of claim 24 further comprising a plurality of aggregated components wherein each aggregated component further comprises one or more base components so that the aggregated component stores information about a topic having one or more types of objects.

36. The taxonomy of claim 24, wherein the abstract base type object further comprises an ItemKind data structure.

37. The taxonomy of claim 26, wherein the plurality of base components further comprises one or more of a BlogKind, a ContactKind, a LinkKind, a MediaKind, a DocumentKind, a MessageKind, a CalendarKind, an EventKind, a To-DoKind, a TaskKind, and a PhotoKind.

38. The taxonomy of claim 25, wherein the abstract base type object, the plurality of base components and the plurality of aggregated components each further comprise XML data.

39. The taxonomy of claim 27, wherein the MediaKind further comprises an AudioKind, a VideoKind and a PhotoKind, the MessageKind further comprises an Email-MessageKind and a Text-MessageKind and wherein the Text-MessageKind further comprises an IM MessageKind.

40. The taxonomy of claim 25, wherein the plurality of aggregated components further comprises one or more of an ApparelKind, an AutoKind, a BookKind, a MovieKind, a MusicKind, a Real EstateKind, a VideoGameKind and a WineKind.

41. The taxonomy of claim 24 further comprising creating a new base component for a new type of object, the new base component describing the new type of object and encapsulating the underlying content of the new type of object within a generic content element wherein the new type of object is represented by the new base component.

42. The taxonomy of claim 24, wherein the plurality of base components further comprises a vertical application domain item based on a base component that has a vertical application domain semantic property element.

43. The taxonomy of claim 24, wherein the abstract base type object further comprises a views element, an actions element and a constraints element wherein the views element describes zero or more display types associated with the abstract base type object, the actions element describes zero or more actions associated with the abstract base type object and the constraints element describes zero or more constraints associated with the abstract base type object.

44. The taxonomy of claim 43, wherein the views element, actions element and constraints element associated with the abstract base type object are inherited by the base component types that extend the abstract base type object.

45. The taxonomy of claim 24, wherein each base component further comprises a views element, an actions element and a constraints element wherein the views element describes zero or more display types associated with the base component, the actions element describes zero or more actions associated with the base component and the constraints element describes zero or more constraints associated with the base component.

46. The taxonomy of claim 45, wherein the views element, actions element and constraints element associated with a particular base component type are inherited by the objects that are derived from that particular base component type.
